(19) United States
(12) Patent Application Publication
(10) Pub. No.: US 2002/0187359 A1
(43) Pub. Date: Dec. 12, 2002

(54) Multilayer devices having composite layer of frequency agile materials and method of making the same

(76) Inventors: Xunhu Dai, Gilbert, AZ (US); David L. Wilcox, Chandler, AZ (US); Rong-Fong Huang, Tempe, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/200,769

(22) Filed: Jul. 22, 2002

Related U.S. Application Data
(63) Continuation of application No. 09/696,497, filed on Oct. 25, 2000.

(51) Int. Cl. B32B 15/04

(52) U.S. Cl. 428/469; 428/336

(57) ABSTRACT

Devices (20)/(32) include respectively a conductive layer (22)/(34) having a plurality of ceramic phases (26, 28, 30)/(38, 40, 42). Devices are prepared in a receptacle (10) having a colloidal suspension of ceramic particles, a first electrode (12), a second electrode (14) and a power source (16). A substrate with a conductive layer is affixed to one of the electrodes and a voltage is applied to deposit particles on the conductive layer.

### FIELD OF THE INVENTION

The present invention relates to electronic devices having a composite layer including a ceramic material, and more particularly to electronic devices having a composite layer of at least two different ceramic materials, which is on a conductive layer.

### BACKGROUND OF THE INVENTION

In the manufacture of many electronic devices it is common to employ a dielectric layer, such as a ceramic material, on a conductive layer. Recent advances in ceramic technology, including advancements in the field of frequency agile materials for electronics (i.e., materials that exhibit variable dielectric constants over a range of temperatures in the presence of an electrical field), along with the desire to further reduce the size of microelectronic devices for a variety of applications (e.g., wireless or portable applications requiring thin film layers for realizing high fields from relatively small available voltages) have fueled the search for improved ways to manufacture such devices.

Traditionally, thin film deposition techniques (e.g., PVD, CVD, MOD, MOCVD, MBE, PLD, sputter-coating, sol-gel, or the like) have been employed to deposit a single-phase layer of dielectric on a conductive layer, or on a conductive fiber. Unfortunately, the ability to fabricate a relatively thin composite layer including at least two different ceramics in such layer (for enhanced tunability), has been limited by virtue of the difficulty of introducing the different ceramics in a controlled and reproducible manner. Accordingly, there is a need for an improved fabrication technique, pursuant to which relatively thin ceramic composite layers can be efficiently and reproducibly formed on a conductive layer.

### BRIEF DESCRIPTION OF THE DRAWINGS

FIG. 1 is a side sectional view of one illustrative apparatus for depositing ceramics onto a conductive layer.

FIG. 2 is a side sectional view of one illustrative multilayer device prepared in accordance with the present invention.

FIG. 3 is a side sectional view of another illustrative multilayer device prepared in accordance with the present invention.

### DETAILED DESCRIPTION OF THE DRAWINGS

The present invention is premised upon a unique combination of materials in a multi-layered electronic device, as well a method and system for fabricating such combination.

In general the method of fabricating a device in accordance with the present invention includes the steps of:

a) providing a substrate with a conductive material over at least a portion of its surface;

b) providing a liquid suspension of at least two different ceramic particles;

c) modifying the surface charge of the ceramic material particles;

d) placing the substrate in said suspension;

e) applying an electric field in the suspension; and

f) forming a composite layer of the at least two different ceramic material particles on the conductive material.

The substrate useful in the present invention may be any suitable substrate, including but not limited to semiconductor substrates, conductive substrates, dielectric substrates, or the like. The substrate preferably includes a conductive material over at least a portion of its surface, which conductive layer may or may not be patterned. In a preferred embodiment, the conductive material includes a conductive metal, and more preferably one selected from the group consisting of silver, nickel, copper, gold, silver, platinum, and combinations thereof. The conductive layer may be disposed at or adjacent a surface of the substrate, and in electrical communication relationship with material in the substrate.

To form a thin ceramic composite layer on the conductive material, a liquid suspension is provided, which includes a suspension of at least two different compositions or forms of particulated ceramic materials. Preferably, the liquid suspension is a substantially stable colloidal suspension. Thus, during processing, a substantial portion of the suspended ceramic particles (e.g., greater than half, and preferably greater than three-quarters) will remain suspended in the presence of an applied potential. In one embodiment, the suspension includes a suitable liquid medium (e.g., an alcohol, such as methanol, ethanol, isopropanol or mixtures thereof) , and a dispersant such as an ionic (e.g., anionic or cationic) surfactant (e.g., without limitation, available under the trademarks, a phosphate ester available from WITCO, Phosphorus- ESTE™ or the like). In one embodiment, the suspension will also preferably include one or more agents for altering the pH of the suspension or otherwise altering the surface charge or modifying the Zeta potential of the suspended particles, and thereby enhancing mobility of the particles in the suspension. The concentration of the components is not critical, as the skilled artisan will appreciate, and may vary depending upon processing times, temperatures, or particle size, composition or surface characteristics.

In a particularly preferred embodiment, the ceramic particles suspended in the solution will be a fine powder, and will have an average particle diameter up to about 10 microns. More preferably the average diameter will range from about 0.01 to about 5 microns, and still more preferably will be about 0.03 to about 3 microns. The ceramic particles may be high purity particles or commercial grade.

Preferably the ceramics include at least one oxide capable of being deposited to form at least one frequency agile material. In one embodiment, the ceramics include one or more oxides of Ti, Ba, Sr, Mg, Bi, Nb, Zn or mixtures thereof. By way of illustration, in one preferred embodiment, at least one of the oxides in the colloidal suspension is an oxide of titanium (and may include TiO₃, TiO₂ or both). In another embodiment, at least one of the oxides includes a combination of Ba and Sr, such as according to the formula (BaₓSr₁₋ₓ)TiO₃, where x ranges from 0 to 1. Preferably, a second oxide (such as one including an element selected from Ti, Mg, Bi, Nb, Zn or mixtures thereof) is also employed. In a particularly preferred embodiment, the combination of oxides includes a frequency agile material (e.g., (Ba_{0.6}Sr_{0.4})TiO₃) and a second oxide that exhibits a relatively low dielectric constant and relatively high value for Q (e.g., without limitation, MgO or TiO₂).

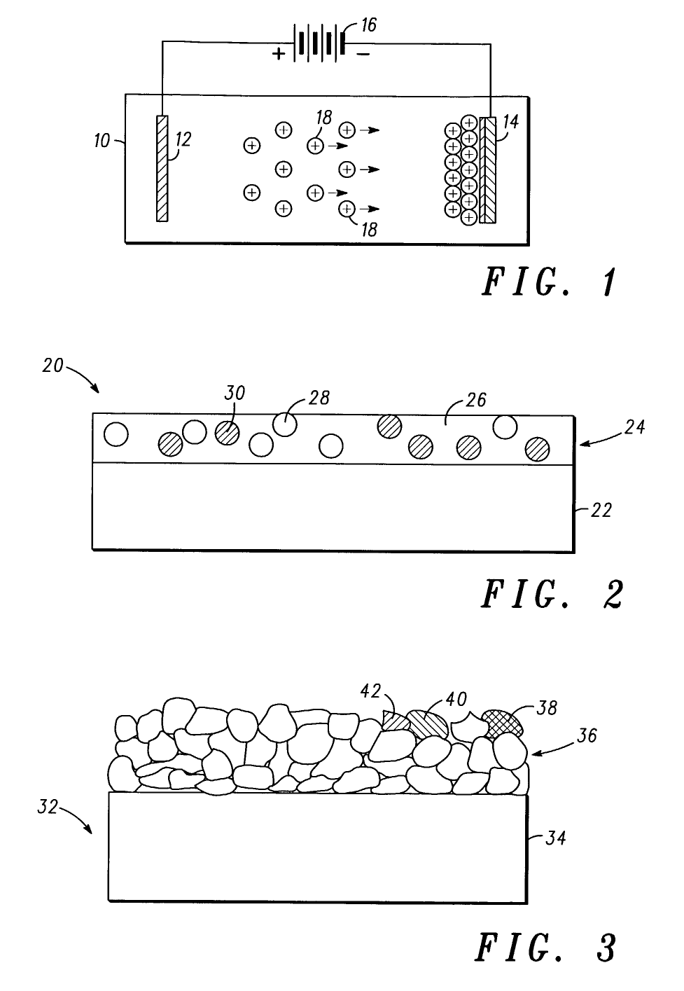

In a preferred embodiment, referring to FIG. 1, a receptacle 10 is provided for containing the colloidal suspension of one or more of the at least two different ceramic materials and for facilitating electrophoretic deposition of the ceramic materials onto the conductive substrate, which substrate (or conductive layer on it) optionally may be pre-patterned as desired. The receptacle 10 is equipped with a first electrode 12 and a second electrode 14 (which includes a mounting fixture (not shown) for receiving and electrically communicating with the substrate with a conductive layer). A voltage source 16 is provided in electrical communication between the first and second electrodes. Upon having the colloidal suspension contained in the receptacle 10 in a desired amount, and the substrate affixed to an electrode, a voltage is applied. As depicted in FIG. 1, the particles in suspension will exhibit positive charge characteristics and in the presence of an electrical field, a plurality of the charged particles 18 will migrate toward and contact the substrate associated with the second electrode, causing a deposition of the particles onto the substrate. It will be appreciated that the substrate may be affixed to the first electrode in alternative embodiments.

The voltage is applied in an amount and for an amount of time to deposit a desired amount of the suspended ceramic material (preferably containing at least two different ceramics) on the substrate. For instance, in one preferred embodiment, the deposition is performed to form a composite layer of at least two different ceramics, having a thickness up to about 15 microns, more preferably up to about 10 microns, and still more preferably up to about 5 microns. Alternatively, the thickness of the composite layer ranges from about 0.1 to about 15 microns, and more preferably about 0.5 to about 10 microns.

The skilled artisan will appreciate that different ceramics may be deposited onto a substrate serially (e.g., by placement in at least two different suspensions) or simultaneously (e.g., by containing more than one ceramic in a single suspension). Thus, each of the different ceramic materials can be dispersed in a thin layer, either randomly, substantially uniformly or according to a predetermined pattern (which may be governed as well by the pattern of the conductive layer of the substrate.

By way of further illustration, without limitation, FIG. 2 illustrates a first multiplayer device 20 conductive layer 22 onto which a multiphase composite layer 24 of ceramic material is deposited. The composite layer 24 includes a predominant first phase 26 effectively serving as a matrix, a second phase 28 and third phase 30 dispersed throughout the first phase 26. FIG. 3 illustrates a second multiplayer device 32 having a conductive layer 34 onto which a multiphase composite layer 36 of ceramic material is deposited. The composite layer 36 is shown having different phases, namely a first phase 38, a second phase 40 and a third phase 42. The phases are generally randomly but homogeneously dispersed throughout the composite layer 36.

It will be realized that the present invention provides a unique approach toward devices exhibiting low dielectric constant, but high Q values. Accordingly, the multilayer devices of the present invention are useful in a variety of different applications, notably in the field of portable or wireless communication devices, or other applications requiring low voltage formats. The present invention thus contemplates such portable or wireless communication devices as within its scope as well.

The skilled artisan will also appreciate that a variety of modifications may otherwise be made as desired, including but not limited to the incorporation of fugitive materials to form a porous layered structure; the incorporation of glass powder in dielectric to help achieve low temperature co-fireability with other LTCC materials; or the formation of composite organic/inorganic structures for mechanical applications.

The following examples also serve to illustrate, without limitation, the concepts of the present invention.

### EXAMPLE 1

About 2 grams of BaTiO₃ with a particle size d₅₀ of about 50 nm and about 1 gram of TiO₂ with a particle size d₅₀ of about 50 nm are added into about 500 ml 85% ethanol to form a colloidal solution. A phosphate ester, PS-21A from Witco, at about 2% by weight of the ceramic content is added to the solution to help the powder disperse. The solution is horned ultrasonically, and followed by a ball mill in a 1000 ml jar with about 5 kg ½-inch zirconia media for about 10 hours.

The electropheretic deposition (EPD) of ceramic powder is done or a sputtered gold (Au) layer on a mylar film. The Au layer is connected to the negative side of the power supply while an aluminum plate, which is 1 cm away from the mylar, is connected to the positive side. A ceramic layer is deposited to the Au under about 300 V DC for about 1-3 minutes. SEM and XRD examination show that the layer includes a composite of BaTiO₃ and TiO₂.

### EXAMPLE 2

About 2 grams of SrTiO₃ with a particle size d₅₀ of about 50 nm and about 1 gram of TiO₂ with a particle size d₅₀ of about 50 nm are added into about 500 ml 85% ethanol to form a colloidal solution. A phosphate ester, PS-21A from Witco, at about 2% by weight of the ceramic content is added to the solution to help the powder dispersion. The solution is horned ultrasonically, and followed by a ball mill in a 1000 ml jar with 5 kg ½-inch zirconia media for about 10 hours.

The electropheretic deposition (EPD) of ceramic powder is done on a sputtered Au layer on a mylar film. The Au layer is connected to the negative side of the power supplier while an aluminum plate, which is about 1 cm away from the mylar, is connected to the positive side. A ceramic layer is deposited to the Au under about 300 V DC for about 1-3 minutes. SEM and XRD examination show that the layer includes a composite of SrTiO₃ and TiO₂.

### EXAMPLE 3

About 1 gram of BaTiO₃ with a particle size d₅₀ of about 50 nm, 1 gram of SrTiO₃ with a particle size d₅₀ of about 50 nm and about 1 gram of TiO₂ with a particle size of d₅₀ of about 50 nm are added into about 500 ml 85% ethanol to form a colloidal solution. A phosphate ester, PS-21A from Witco, at about 2% by weight of the ceramic content is added to the solution to help the powder dispersion. The solution is horned ultrasonically, and followed by a ball mill in a 1000 ml jar with 5 kg ½-inch zirconia media for about 10 hours.

The electropheretic deposition (EPD) of ceramic powder is done on a sputtered Au layer on a mylar film. The Au layer is connected to the negative side of the power supplier while an aluminum plate, which is 1 cm away from the mylar, is connected to the positive side. A ceramic layer is deposited to the Au under 300 V DC for about 1-3 min. SEM and XRD examination show that the layer includes a composite of BaTiO₃ SrTiO₃ and TiO₂.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method for making an electronic device, comprising the steps of:
a) providing a substrate with a conductive material over at least a portion of its surface;
b) providing a liquid suspension of at least two different ceramic particles;
c) modifying the surface charge of said ceramic material particles;
d) placing said substrate in said suspension;
e) applying an electric field in said suspension; and
f) forming a composite layer of said at least two different ceramic material particles on said conductive material.

2. An electronic device, comprising:
a substrate having a conductive element associated with a surface of said substrate;
a thin composite layer on said conductive portion including at least two different ceramic materials for forming a frequency agile material for electronics.

3. An electronic device, comprising:
a dielectric substrate having a conductive metallic element associated with a surface of said substrate;
a composite layer, having a thickness up to about 15 microns, disposed on said conductive metallic element at least two different ceramic components selected from the oxides of Ti, Ba, Sr, Mg, Bi, Nb, Zn or mixtures thereof, for forming a frequency agile material for electronics.

4. The method of claim 1, wherein said liquid suspension is a colloidal suspension.

5. The method of claim 1, wherein the pH of said liquid suspension is changed for modifiying the surface charge of said ceramic particles.

6. The method of claim 1, wherein said electric field is applied in said suspension by applying a voltage between at least two electrodes, at least one of said electrodes being in electrical communication with said conductive material of said substrate.

7. The method of claim 6, wherein said composite layer is formed by the migration of at least two different surface charge modified ceramic particles toward said at least electrode in electrical communication with said conductive material of said substrate.

8. The method of claim 1, wherein said surface charge modification step includes modification of the pH of a suspension including powders of at least two different ceramic components selected from the oxides of Ti, Ba, Sr, Mg, Bi, Nb, Zn or mixtures thereof, said powders being suitable for forming a frequency agile material for electronics.

9. The method of claim 1, wherein said forming step (f) includes forming a layer having a thickness up to about 15 microns.

10. The method of claim 1, wherein said forming step (f) includes forming a layer having a thickness up to about 10 microns.

11. The method of claim 1, wherein said forming step (f) includes forming a layer having a thickness up to about 5 microns.

12. The device of claim 2, wherein said thin layer has a thickness up to about 15 microns.

13. The device of claim 2, wherein said thin layer has a thickness up to about 10 microns.

14. The device of claim 2, wherein said thin layer has a thickness up to about 5 microns.

15. The device of claim 2, wherein said ceramic materials include at least two different ceramic powders selected from the oxides of Ti, Ba, Sr, Mg, Bi, Nb, Zn or mixtures thereof, said powders being suitable for forming a frequency agile material for electronics.

16. The device of claim 2, wherein said different ceramic materials are randomly dispersed in said thin layer.

17. The device of claim 2, wherein each of said different ceramic materials is substantially uniformly dispersed in said thin layer.

18. The device of claim 2, wherein each of said different ceramic materials is dispersed in said thin layer according to a predetermined pattern.

19. The device of claim 3, wherein said thin layer has a thickness of about 0.1 to about 15 microns.

20. The device of claim 3, wherein said thin layer has a thickness of about 0.5 to about 10 microns.

21. The device of claim 3, wherein said thin layer has a thickness of about 1 to about 5 microns.

22. The device of claim 3, wherein said different ceramic materials are randomly dispersed in said thin layer.

23. The device of claim 3, wherein each of said different ceramic materials is substantially uniformly dispersed in said thin layer.

24. The device of claim 3, wherein each of said different ceramic materials is dispersed in said thin layer according to a predetermined pattern.
